(19) United States
(12) Patent Application Publication
(10) Pub. No.: US 2008/0280269 A1
(43) Pub. Date: Nov. 13, 2008

(54) A Homework Assignment and Assessment System for Spoken Language Education and Testing

(76) Inventors: Minerva Yeung, Los Altos Hills, CA (US); Robert Du, Shanghi (CN); Boon-Lock Yeo, Los Altos Hills, CA (US)

Correspondence Address: BLAKELY SOKOLOFF TAYLOR & ZAFMAN LLP, 1279 OAKMEAD PARKWAY, SUNNYVALE, CA, 94085-4040, US

(21) Appl. No.: 10/577,623

(22) PCT Filed: May 27, 2005
(86) PCT No.: PCT/CN05/00746

§ 371 Date: Apr. 28, 2006

(51) Int. Cl. G09B 19/06; G09B 5/04; G09B 5/00; G06F 15/16; G09B 19/04

(52) U.S. Cl. 434/157; 434/185; 434/307 R; 709/203

(57) ABSTRACT

A language tutor system and method. The system comprising a client module and a server module coupled to the client module. The server module downloads an oral language assignment to the client module to enable a student learning a second language to login to the client module and perform the oral language assignment. The client module provides a benchmark audio sentence in the second language to the student, records a recitation of the sentence from the student, and evaluates the recitation of the sentence from the student by comparing the recitation of the sentence with the benchmark audio. The system provides feedback to the student on the pronunciation and intonation of each word in the sentence.

### BACKGROUND OF THE INVENTION

1. Field of the Invention

The present invention is generally related to a computer-aided language tutor. More particularly, the present invention is related to a homework assignment and assessment system for spoken language education and testing.

2. Description

When learning to speak a second language or a native language, students need lots of oral practice. Traditional classroom learning does not allow each student the opportunity to have many chances to speak orally in class, especially when the student to teacher ratio is large (that is, one teacher teaching many students). To provide students with enough oral practice, teachers often require the students to read their lessons as homework. Unfortunately, traditional methods cannot check whether the students have carefully read their homework assignments. Traditional methods of oral language testing require each student to use a tape recorder to record the student's pronunciation and then have a team of judges to provide feedback on the performance of each student. Not only is this method time consuming, but it is also subjective.

Thus, what is needed is a computer-aided assignment and assessment system and method for enabling a teacher to assign oral practice assignments to each student. What is also needed is a computer-aided assignment and assessment system and method for objectively assessing the quality of the student's pronunciation and intonation of the spoken language. What is further needed is a computer-aided assignment and assessment system that monitors each student's progress to enable the teacher to provide constructive feedback to each student.

### BRIEF DESCRIPTION OF THE DRAWINGS

The accompanying drawings, which are incorporated herein and form part of the specification, illustrate embodiments of the present invention and, together with the description, further serve to explain the principles of the invention and to enable a person skilled in the pertinent art(s) to make and use the invention. In the drawings, like reference numbers generally indicate identical, functionally similar, and/or structurally similar elements. The drawing in which an element first appears is indicated by the leftmost digit(s) in the corresponding reference number.

FIG. 1 is a block diagram illustrating an exemplary client/server based assignment and assessment language learning system according to an embodiment of the present invention.

FIG. 2 is a flow diagram describing an exemplary method for enabling a student to perform oral practice assignments on a Virtual Language Tutor (VLT) online client according to an embodiment of the present invention.

FIG. 3 is a diagram illustrating an exemplary homework assignment according to an embodiment of the present invention.

FIG. 4 is a flow diagram describing an exemplary method for performing a homework assignment on a VLT online client according to an embodiment of the present invention.

FIG. 5 is a diagram illustrating an exemplary screen shot of feedback and grading provided by a VLT online client after a response to a sentence according to an embodiment of the present invention.

FIG. 6 is a diagram of an exemplary screen shot of a user interface for a VLT online client according to an embodiment of the present invention.

FIG. 7 is a flow diagram describing a method for student interaction with a VLT online server according to an embodiment of the present invention.

FIG. 8 is a flow diagram describing a method for enabling a teacher to prepare an assignment for a class.

FIG. 9 is a flow diagram describing a method for enabling a teacher to evaluate student homework and provide feedback according to an embodiment of the present invention.

FIG. 10 is an exemplary completion status report according to an embodiment of the present invention.

FIG. 11 is an exemplary statistical performance report according to an embodiment of the present invention.

FIG. 12 is a block diagram illustrating an exemplary computer system in which certain aspects of the invention may be implemented.

### DETAILED DESCRIPTION OF THE INVENTION

While the present invention is described herein with reference to illustrative embodiments for particular applications, it should be understood that the invention is not limited thereto. Those skilled in the relevant art(s) with access to the teachings provided herein will recognize additional modifications, applications, and embodiments within the scope thereof and additional fields in which embodiments of the present invention would be of significant utility.

Reference in the specification to “one embodiment”, “an embodiment” or “another embodiment” of the present invention means that a particular feature, structure or characteristic described in connection with the embodiment is included in at least one embodiment of the present invention. Thus, the appearances of the phrase “in one embodiment” or “in an embodiment” appearing in various places throughout the specification are not necessarily all referring to the same embodiment.

Embodiments of the present invention are directed to an assignment and assessment language learning system and method for teaching students a language. With the use of text-speech mapping, speech analysis, pattern recognition, and data mining technologies, embodiments of the present invention facilitate the oral teaching, learning, and testing of a language to students in an efficient and flexible manner. The system enables a teacher to assign oral language assignments to students in language education. Upon completion of an oral language assignment by the student, the system provides the student and teacher with an objective and accurate evaluation on the quality of the student's pronunciation and intonation of the oral language assignment. The system also enables the teacher to closely monitor each student's progress and to select homework assignments geared toward correcting student weaknesses.

Although embodiments of the present invention are described with Chinese as the native language and English as the second language, the invention is not limited to teaching a second language. One skilled in the relevant art(s) would know that the invention is applicable to native language training as well.

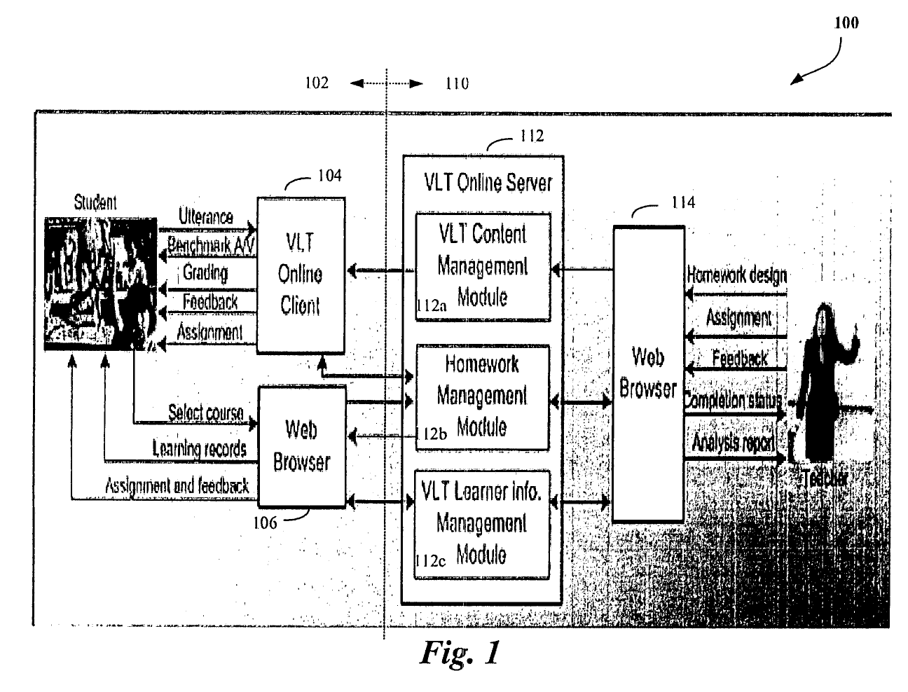

FIG. 1 is a block diagram illustrating an exemplary client/server based assignment and assessment language learning system 100 according to an embodiment of the present invention. System 100 comprises a client side 102 and a server side 110. Client side 102 comprises a virtual language tutor (VLT) online client 104 and a client web browser 106 for enabling a student to interact with system 100. Server side 110 comprises a virtual language tutor (VLT) online server 112 and a server web browser 114 for enabling a teacher to interact with system 100. Both VLT online client 104 and VLT online server 112 reside on a network, such as, for example, an Intranet or an Internet network. VLT online server 112 is coupled to VLT online client 104, client web browser 106, and server web browser 114.

A student may communicate with VLT online client 104 via a student computing device (not shown), such as a personal computer (PC), a lap top computer, a notebook computer, a workstation, a server, a mainframe, a hand-held computer, a palm top computer, a personal digital assistant (PDA), a telephony device, etc. Signals sent from VLT online client 104 to the student via the computing device include Assignment, Feedback, Grading, and Benchmark A/V signals. Signals sent to VLT online client 104 from the student include oral recitations of the Benchmark A/V signals, shown in FIG. 1 as Utterance signals. Assignment, Feedback, Grading, Benchmark A/V, and Utterance signals will be described in further detail below.

Virtual language tutor online server 112 comprises a virtual language tutor content management module 112a, a homework management module 112b, and a virtual language tutor learner information management module 112c. VLT content management module 112a comprises content modules that may be used for assignments, or to prepare assignments. Content for an assignment may be obtained from a plurality of sources, such as, for example, lectures, speeches, audio tapes, excerpts from audio books, etc. The content may be imported into content management module 112a with the aid of an administrator of system 100. Homework Management Module 112b allows the teacher to assign homework assignments to one or more students, one or more classes, etc. The homework assignments are selected by the teacher from content management module 112a. VLT Learner Information Management Module 112c comprises learning histories for all students that have previously used system 100. When a homework assignment has been completed by a student, the status of the homework assignment as well as the feedback and grading that results from the analysis of the homework by VLT online client 104 are uploaded to VLT online server 112 and immediately becomes part of the student's learning history in VLT Learner Information Management Module 112c. The status of the homework assignment including the feedback and grading of the homework assignment are now accessible to the teacher. Learning histories may be provided to the individual student or to the teacher. Unless special permissions are provided, a student may only access his/her own learning history.

A student may communicate with VLT online server 112 via client web browser 106 using the computing device as well. In fact, in one embodiment, client web browser 106 may reside on the student computing device. In this instance, the student may select a language course offered by VLT online server, receive learning histories or records from previous assignments performed by the student and receive feedback from the teacher for one or more previous completed assignments.

A teacher may communicate with VLT online server 112 via server web browser 114 using a teacher computing device (not shown), such as a personal computer (PC), a lap top computer, a notebook computer, a workstation, a server, a mainframe, a hand-held computer, a palm top computer, a personal digital assistant (PDA), a telephony device, etc. In fact, in one embodiment, server web browser 114 may reside on the teacher computing device. Signals provided to the teacher from VLT online server 112 (via server web browser 114) include student completion status and analysis reports. Signals sent from the teacher (via the teacher computing device) to VLT online server 112 include homework design, assignment, and feedback. Student completion status, analysis reports, homework design, assignment, and feedback signals will be discussed in further detail below.

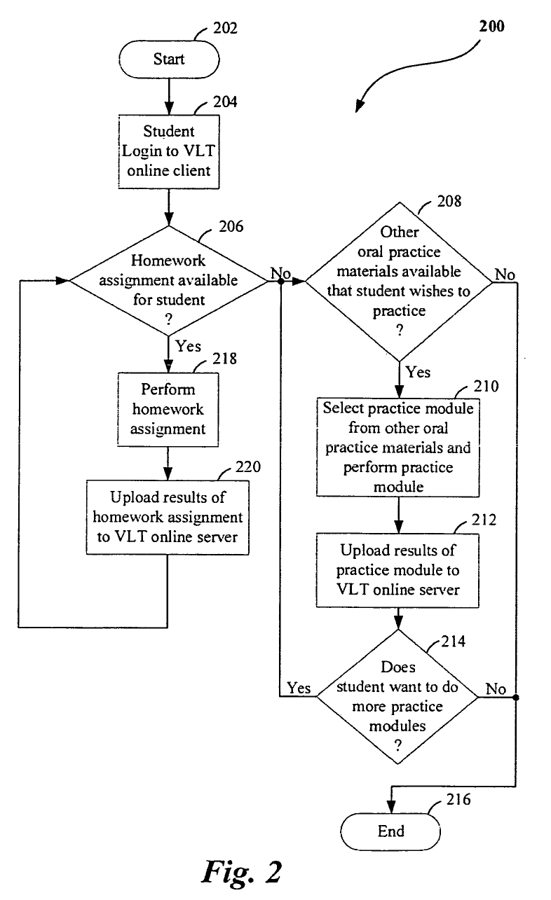

VLT online client 104 comprises client software that enables a student to obtain oral practice assignments assigned by the teacher, perform the oral practice assignments, and receive performance results or feedback and grading based on their performance of the oral practice assignments. FIG. 2 is a flow diagram describing an exemplary method for enabling a student to perform oral practice assignments on VLT online client 104 according to an embodiment of the present invention. The invention is not limited to the embodiment described herein with respect to flow diagram 200. Rather, it will be apparent to persons skilled in the relevant art(s) after reading the teachings provided herein that other functional flow diagrams are within the scope of the invention. The process begins with block 202, where the process immediately proceeds to block 204.

In block 204, a student may log on to VLT online client 104 using a computing device, such as a personal computer (PC), a workstation, a server, a mainframe, a hand-held computer, a palm top computer, a personal digital assistant (PDA), a telephony device, a network appliance, a convergence device, etc. Login procedures consisting of the student providing a user identification (ID) and a password are well known in the relevant art(s). Once the student has logged onto VLT online client 104, the process proceeds to decision block 206.

In decision block 206, it is determined whether a homework assignment is available for the student. If a homework assignment is not available for the student, then either the student has completed all of their current homework assignments or the teacher has not assigned any new homework assignments. In this case, the process proceeds to decision block 208.

In decision block 208, it is determined whether other oral practice materials are available for training the student that the student may use as a practice module. If other oral practice materials are available for training the student, the process proceeds to block 210.

In block 210, the student may select an oral practice module from the other oral practice materials and perform the module. Upon completion of the practice module, the results of the practice module are uploaded to VLT online server 112 (block 212). The process then proceeds to decision block 214 to query the student as to whether the student desires to continue practicing. If the student desires to continue practicing, the process proceeds back to decision block 208 to determine whether another practice module is available.

In decision block 208, if it is determined that there are no practice modules available, the process proceeds to block 216, where the process ends.

Returning to decision block 214, if it is determined that the student does not wish to continue practicing, then the process proceeds to block 216, where the process ends.

Returning to decision block 206, if it is determined that a homework assignment is available for the student, the process proceeds to block 218. In block 218, the student may perform the homework assignment on VLT online client 104. Upon completion of the homework assignment, the results of the homework assignment, including status completion results, feedback and grading (that is, analysis results), are uploaded to VLT online server 112 (block 220). The process then proceeds back to decision block 206 to determine whether another homework assignment is available.

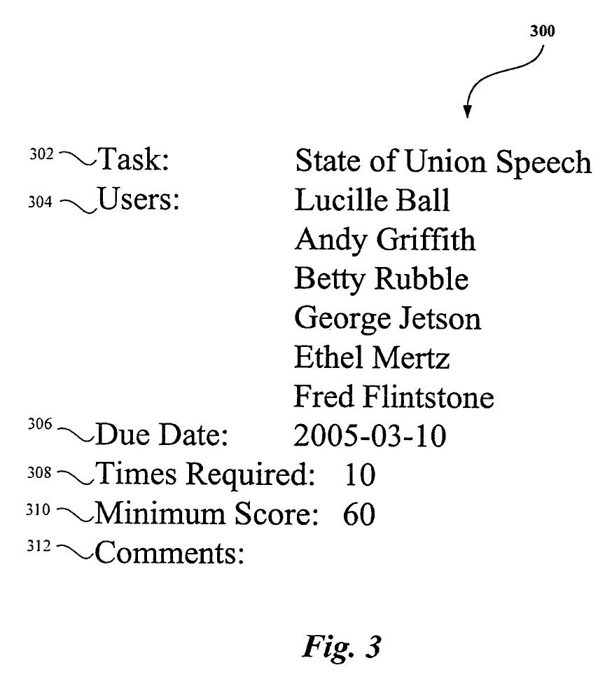

An exemplary homework assignment 300 is shown in FIG. 3. Exemplary homework assignment 300 comprises a task 302, a list of students 304 that are to perform the task 304, a due date 306 indicating when the task is to be completed, a number of times 308 that each student is required to complete the task, a minimum score 310 that must be obtained, and any comments 312. Task 302, shown in FIG. 3, comprises a person reciting one or more sentences from the State of the Union Address, which may be presented to the student in the form of a benchmark audio/video. Although homework assignment 300 indicates that each student is to orally practice the task ten (10) times, one skilled in the relevant art(s) would know that the number of times that each student is required to complete the task may be one or more times. In one embodiment, the student has an option of receiving the task in audio format only to conserve bandwidth or in audio/video format.

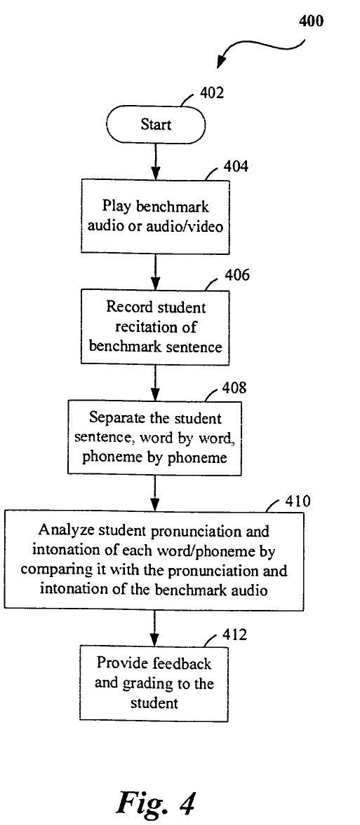

FIG. 4 is a flow diagram describing an exemplary method for performing a homework assignment on a VLT online client according to an embodiment of the present invention. The invention is not limited to the embodiment described herein with respect to flow diagram 400. Rather, it will be apparent to persons skilled in the relevant art(s) after reading the teachings provided herein that other functional flow diagrams are within the scope of the invention. The process begins with block 402, where the process immediately proceeds to block 404.

To perform an oral homework assignment, the student must first listen to the audio portion of the benchmark voice pronunciation and intonation of a sentence by playing the benchmark A/V (block 404). VLT online client 104 plays one sentence of the benchmark A/V at a time when the student presses a play button. The student also has an option of repeating a sentence or moving to the next sentence by pressing a forward or reverse button, respectively. After listening to a sentence, the student may respond in block 406 by pressing a record button and orally repeating the sentence back to VLT online client 104. VLT online client 104 will record the student's pronunciation of the sentence, separate the student's recorded sentence, word by word, and phoneme by phoneme (block 408), and analyze the student's pronunciation and intonation of each word/phoneme by comparing it with the pronunciation and intonation of the benchmark voice (block 410). This is accomplished using forced alignment, speech analysis, and pattern recognition techniques. Speech analysis and pattern recognition techniques are well known in the relevant art(s). Forced alignment is a technique used to match the student's recorded speech with a transcription of the benchmark voice. A method for automatic text-speech mapping is described in a co-pending patent application entitled “Automatic Text-Speech Mapping” to Minerva Yeung et al., filed concurrently with the present application. After comparing the student's response with the benchmark voice, VLT online client 104 will provide feedback and grading to the student (block 412). The feedback and grading provide the student with detailed information regarding pronunciation and intonation, which aids the student in knowing which word or phoneme needs improvement.

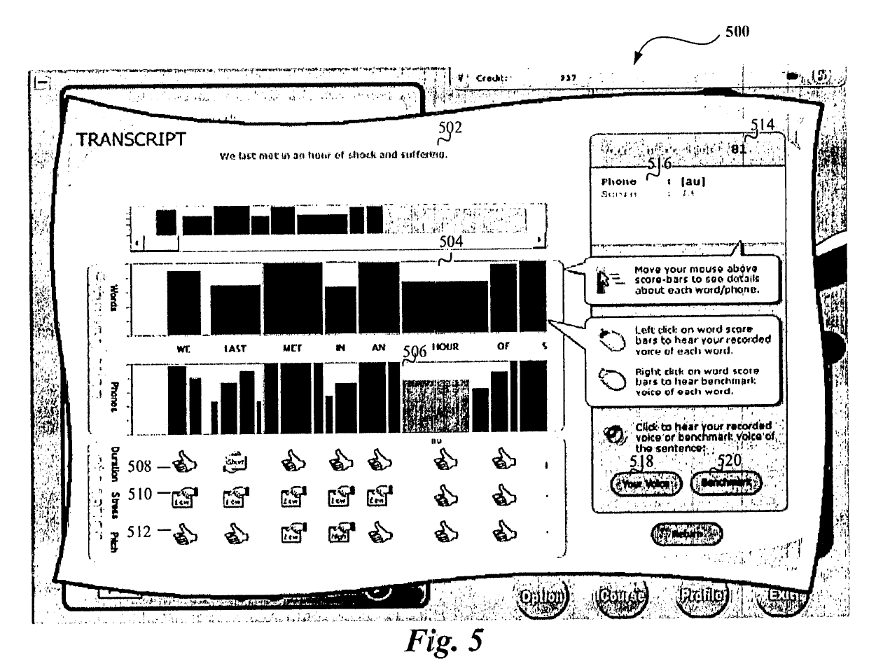

FIG. 5 is a diagram illustrating an exemplary screen shot 500 of feedback and grading provided by VLT online client 104 after a response to a sentence. FIG. 5 shows a sentence from the transcript 502 (that is, the transcript of the benchmark audio portion), the pronunciation results for each word 504 and phoneme 506 (shown as phones in the graph), and the intonation results for each word in the form of duration 508, stress 510, and pitch 512. A thumb up means a good intonation result. A thumb down is a bad intonation result. For duration, the terms short and long are used to indicate that the duration was too short or too long. For stress and pitch, the terms low and high are used to indicate a low/high stress or a low/high pitch, respectively. Screen shot 500 also includes an overall sentence score 514 and an overall phoneme score 516. As indicated in FIG. 5, a student may position his/her mouse above a score bar to see details about each word or phoneme. A student may also hear their recorded voice for each word by a left click of the mouse on the word score bar. A right click of the mouse on the word score bar enables the student to hear the benchmark voice of the word. To hear the student recording, the student may select the “Your Voice” button 518 and to hear the benchmark voice, the student may select the “Benchmark” button 520.

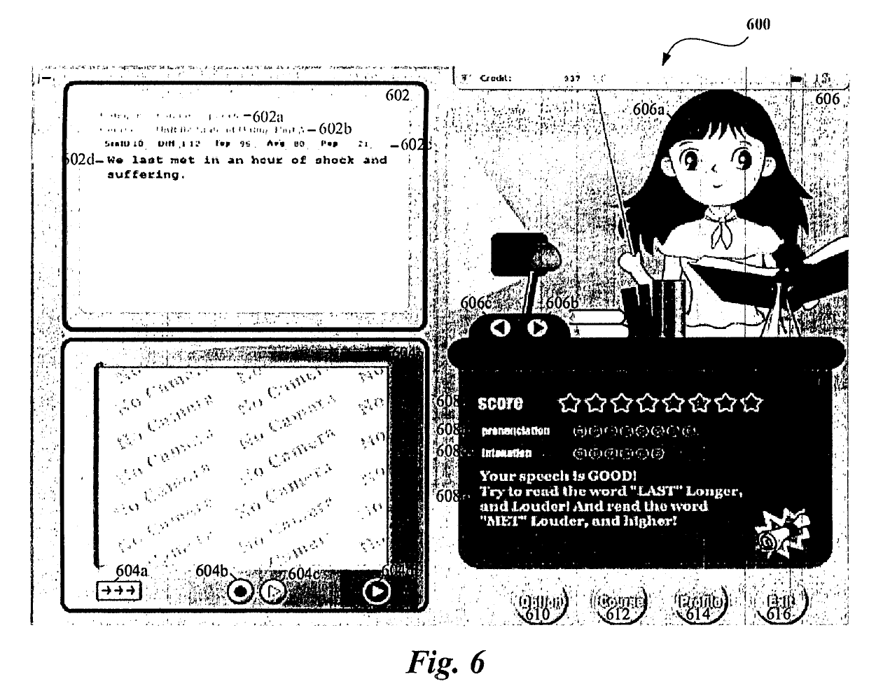

FIG. 6 is a diagram of an exemplary screen shot of a user interface 600 for VLT online client 104. User interface 600 comprises an area showing a transcript of the assignment 602, an area for showing the benchmark A/V 604, an area with a caricature of a teacher 606, and an area for showing the student score 608. User interface 600 also includes an option button 610 which provides optional activities for a student, a course button 612 which provides a list of the assignments available, a profile button 614 which provides profile information on the student, and an exit button 616 which allows the student to exit from VLT online client 104.

Area 602 lists a category 602a, a course or assignment 602b, information regarding a sentence 602c in course 602b, and a transcript of the current sentence 602d. Course 602b may be selected by the student using course button 612. Category 602a lists the category of the selected course or assignment 602b. In this instance, course 602b is “State of Union” and category 602a is “Famous Speech.”

Area 604 provides the benchmark A/V. As previously indicated, in an embodiment, a student may opt to only have the audio portion of the benchmark A/V played. Area 604 also acts a recorder to record the sentence recited by the student. Button 604a is a fast forward button. Button 604a allows the student to fast forward the play of the benchmark A/V. Button 604b is a record button that allows the student to record his/her recited sentence. Button 604c is a playback button that enables the student to play back their own sentence. Button 604d is a play button for playing the benchmark A/V.

Area 606 shows a caricature of a teacher 606a. Also shown in area 606 are forward and reverse buttons 606b and 606c. Forward and reverse buttons 606b and 606c allow a student to advance to the next sentence of the assignment or to go back to the previous sentence, respectively.

Area 608 provides a score box comprising an overall score 608a, a pronunciation score 608b, an intonation score 608c, and feedback 608d. Feedback 608d includes advice on what a student may do to improve their pronunciation and intonation scores.

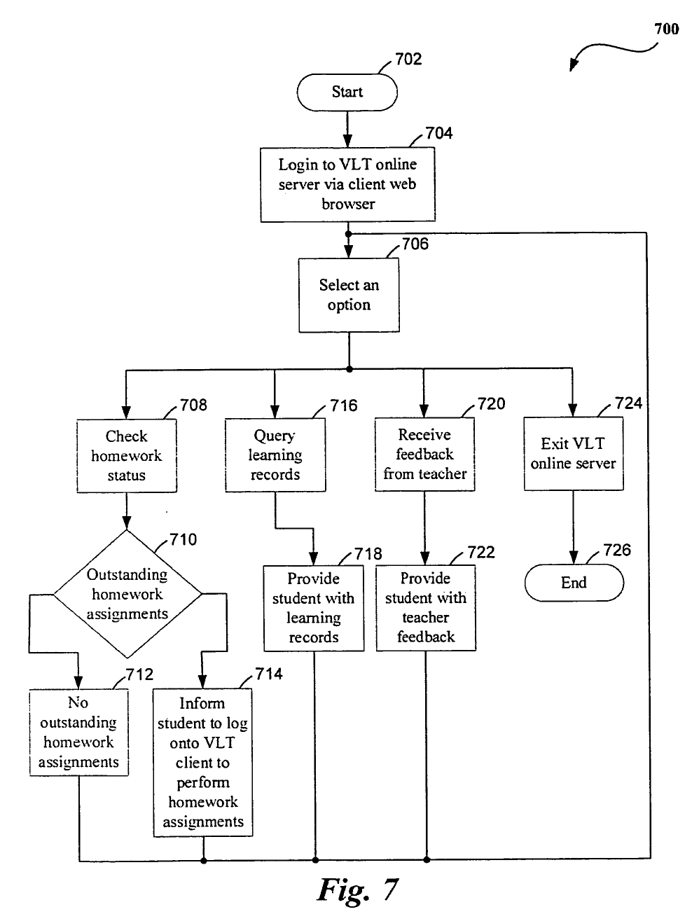

A student may also interact with VLT online server 112 via client web browser 106. FIG. 7 is a flow diagram describing a method for student interaction with VLT online server 112 according to an embodiment of the present invention. The invention is not limited to the embodiment described herein with respect to flow diagram 700. Rather, it will be apparent to persons skilled in the relevant art(s) after reading the teachings provided herein that other functional flow diagrams are within the scope of the invention. The process begins with block 702, where the process immediately proceeds to block 704.

In block 704, a student may log on to VLT online server 112 using their computing device and client web browser 106. As previously indicated, login procedures consisting of the student providing a user identification (ID) and a password are well known in the relevant art(s). Once the student has logged onto VLT online server 112, the student may choose to select one or more of the following in block 706: check homework status (block 708), query their learning records (block 716), get an assessment of their progress from the teacher for a particular assignment (block 720), or exit (block 724).

If the student desires to check their homework status (block 708), the process will proceed to decision block 710. In decision block 710, it is determined whether the student has any outstanding homework assignments. If it is determined that the student does not have any outstanding homework assignments, then the student is informed that all homework assignments have been completed in block 712, and the process proceeds back to block 706.

Returning to decision block 710, if it is determined that the student has one or more outstanding homework assignments to complete, then the process proceeds to block 714. In block 714, the student is informed that they need to log onto VLT online client to complete one or more homework assignments. The process then proceeds back to block 706.

Returning to block 706, if the student decides to query their learning records (block 716), the process proceeds to block 718. In block 718, the student is presented with their learning records. As previously indicated, the learning records include the results of every sentence from every homework assignment and practice module completed by the student. The process then proceeds back to block 706.

Returning to block 706, if the student decides to receive feedback from the teacher (block 720), the process proceeds to block 722. In block 722, the student may obtain teacher feedback from any of the student's previous homework assignments. The process then proceeds back to block 706.

Returning to block 706, if the student decides to exit VLT online server 112 (block 724), the process proceeds to block 726, where the process ends.

As previously indicated, teacher communications with VLT online server 112 include selection of a homework design for a class or individual student, preparation of an assignment for a class, preparing personalized feedback for an individual student as well as the class, receiving completion status for a class, and receiving analysis reports for a class as well as an individual student.

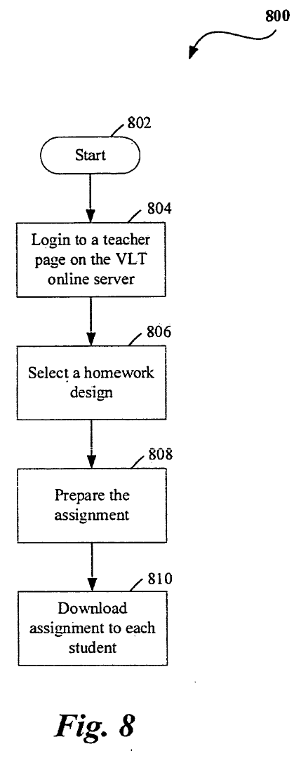

FIG. 8 is a flow diagram 800 describing a method for enabling a teacher to prepare an assignment for a class. The preparation of an assignment for an individual may be done in a similar manner. The invention is not limited to the embodiment described herein with respect to flow diagram 800. Rather, it will be apparent to persons skilled in the relevant art(s) after reading the teachings provided herein that other functional flow diagrams are within the scope of the invention. The process begins with block 802, where the process immediately proceeds to block 804.

In block 804, a teacher may login to a teacher page on VLT online server 112. Login procedures consisting of the teacher providing a user identification (ID) and a password are well known in the relevant art(s). Once the teacher has logged onto VLT online server 112, the teacher page will appear.

In block 806, the teacher may select a homework design from VLT Content Management Module 112a. After the teacher has selected the homework design, the process proceeds to block 808.

In block 808, the teacher may prepare the assignment. Preparing the assignment includes providing the course or task (which is the homework design that was previously selected), the list of students in the class, the due date, the number of times the student is required to repeat the course, the minimum score required, and any comments from the teacher. As previously indicated, an exemplary homework assignment is shown in FIG. 3. The process then proceeds to block 810.

In block 810, the homework assignment is downloaded to each student in the class so that when the student logs on to VLT online client 104 or VLT online server 112 through web browser 106, the student can access the homework assignment.

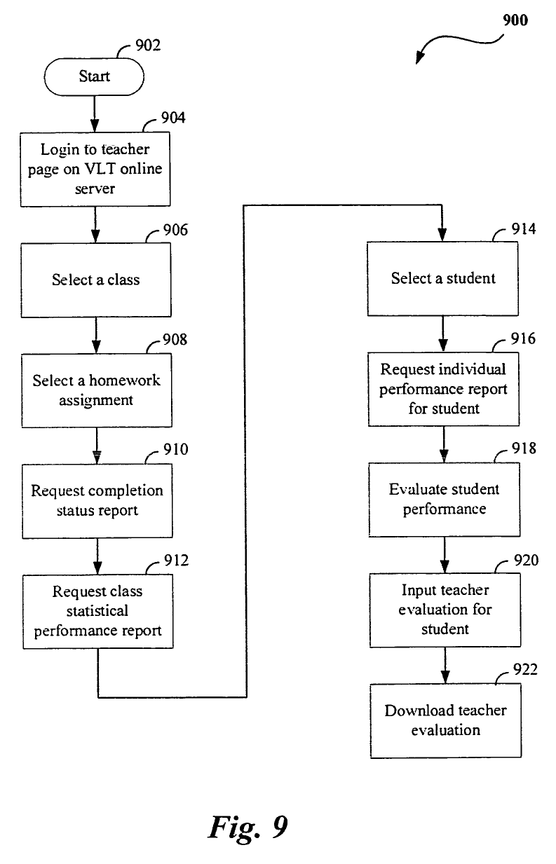

FIG. 9 is a flow diagram 900 describing a method for enabling a teacher to evaluate student homework and provide feedback according to an embodiment of the present invention. The invention is not limited to the embodiment described herein with respect to flow diagram 900. Rather, it will be apparent to persons skilled in the relevant art(s) after reading the teachings provided herein that other functional flow diagrams are within the scope of the invention. The process begins with block 902, where the process immediately proceeds to block 904.

In block 904, a teacher may login to a teacher page on VLT online server 112. Login procedures consisting of the teacher providing a user identification (ID) and a password are well known in the relevant art(s). Once the teacher has logged onto VLT online server 112, the teacher page will appear.

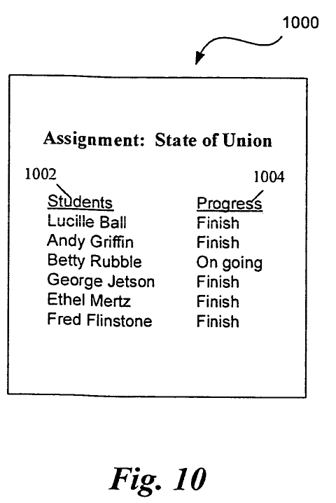

In block 906, the teacher may select a class in which the teacher would like to receive homework results. In block 908, the teacher may select a homework name for the homework assignment of interest to the teacher. The teacher may then request a completion status report in block 910 to see the completion status of the class. An exemplary completion status report 1000 is shown in FIG. 10. Completion status report 1000 shows each student 1002 in the class and their progress 1004. Of the 6 students 1002, only one student did not complete their assignment.

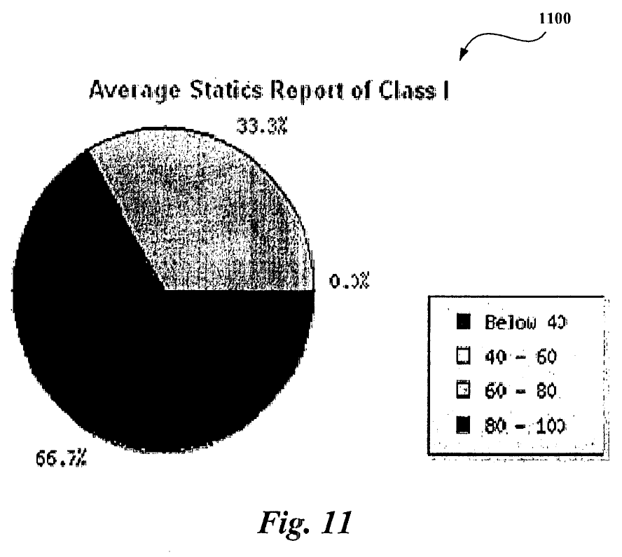

Returning to FIG. 9, in block 912, the teacher may get the class statistical performance report. An exemplary statistical performance report 1100 is shown in FIG. 11. Statistical performance report 1100 shows that 33.3% of the students performed between 60-80 and 66.7% of the students performed between 80-100.

Returning to FIG. 9, in block 914, a teacher may select a student. The teacher may then request the individual performance report for the student in block 916 for evaluation by the teacher. In block 918, the student's performance is evaluated by the teacher. The process then proceeds to block 920.

In block 920, the teacher, upon completing the evaluation, may input the personalized evaluation. In block 922, the evaluation may be downloaded to enable a student to retrieve the personalized evaluation from the teacher. The process then proceeds back to block 914 to select the next student. When all students have been evaluated by the teacher, the process ends.

Although embodiments of the present invention have been described as a client/server based assignment and assessment language learning system and method for teaching students a language, one skilled in the relevant art(s) would know that other environments are also possible. For example, the system may comprise a VLT online module that is coupled to a hard disk drive and/or a removable storage drive, such as a floppy disk drive, a magnetic tape drive, an optical disk drive, etc. Removable storage drives read from and/or write to removable storage units, such as a floppy disk, magnetic tape, optical disk, etc., in a well-known manner. In this embodiment, both the student and teacher may interact with the VLT online module. In one such embodiment, assignments may be in the form of a CD-ROM (Compact Disc Read Only Memory), floppy disk, magnetic tape, optical disk, etc. Student histories may be stored on the hard disk drive, which may be accessible to both the student and the teacher.

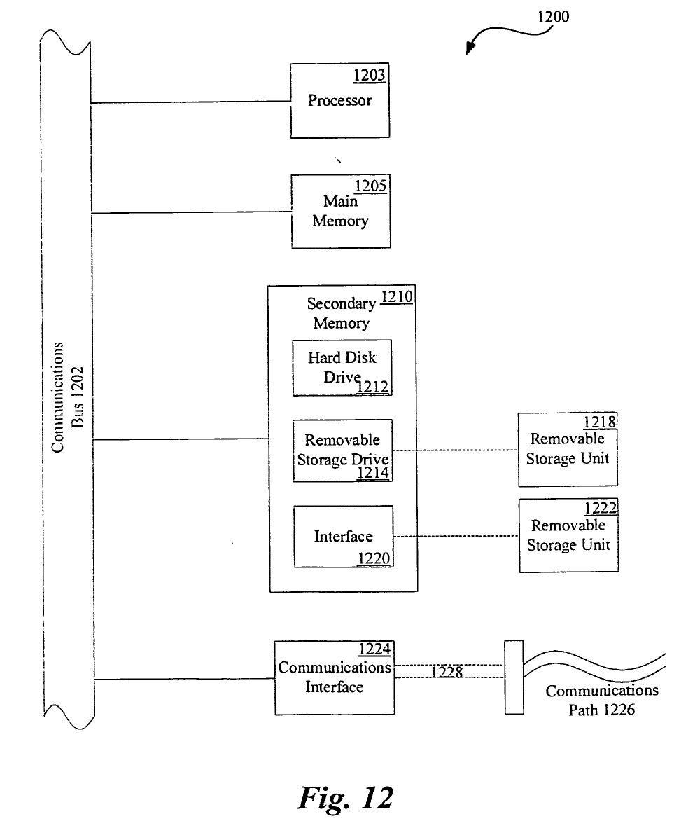

Embodiments of the present invention may be implemented using hardware, software, or a combination thereof and may be implemented in one or more computer systems or other processing systems. In fact, in one embodiment, the invention is directed toward one or more computer systems capable of carrying out the functionality described here. An example implementation of a computer system 1200 is shown in FIG. 12. Various embodiments are described in terms of this exemplary computer system 1200. After reading this description, it will be apparent to a person skilled in the relevant art how to implement the invention using other computer systems and/or computer architectures.

Computer system 1200 includes one or more processors, such as processor 1203. Processor 1203 is connected to a communication bus 1202. Computer system 1200 also includes a main memory 1205, preferably random access memory (RAM) or a derivative thereof (such as SRAM, DRAM, etc.), and may also include a secondary memory 1210. Secondary memory 1210 may include, for example, a hard disk drive 1212 and/or a removable storage drive 1214, representing a floppy disk drive, a magnetic tape drive, an optical disk drive, etc. Removable storage drive 1214 reads from and/or writes to a removable storage unit 1218 in a well-known manner. Removable storage unit 1218 represents a floppy disk, magnetic tape, optical disk, etc., which is read by and written to by removable storage drive 1214. As will be appreciated, removable storage unit 1218 includes a computer usable storage medium having stored therein computer software and/or data.

In alternative embodiments, secondary memory 1210 may include other similar means for allowing computer programs or other instructions to be loaded into computer system 1200. Such means may include, for example, a removable storage unit 1222 and an interface 1220. Examples of such may include a program cartridge and cartridge interface (such as that found in video game devices), a removable memory chip (such as an EPROM (erasable programmable read-only memory), PROM (programmable read-only memory), or flash memory) and associated socket, and other removable storage units 1222 and interfaces 1220 which allow software and data to be transferred from removable storage unit 1222 to computer system 1200.

Computer system 1200 may also include a communications interface 1224. Communications interface 1224 allows software and data to be transferred between computer system 1200 and external devices. Examples of communications interface 1224 may include a modem, a network interface (such as an Ethernet card), a communications port, a PCMCIA (personal computer memory card international association) slot and card, a wireless LAN (local area network) interface, etc. Software and data transferred via communications interface 1224 are in the form of signals 1228 which may be electronic, electromagnetic, optical or other signals capable of being received by communications interface 1224. These signals 1228 are provided to communications interface 1224 via a communications path (i.e., channel) 1226. Channel 1226 carries signals 1228 and may be implemented using wire or cable, fiber optics, a phone line, a cellular phone link, a wireless link, and other communications channels.

In this document, the term “computer program product” refers to removable storage units 1218, 1222, and signals 1228. These computer program products are means for providing software to computer system 1200. Embodiments of the invention are directed to such computer program products.

Computer programs (also called computer control logic) are stored in main memory 1205, and/or secondary memory 1210 and/or in computer program products. Computer programs may also be received via communications interface 1224. Such computer programs, when executed, enable computer system 1200 to perform the features of the present invention as discussed herein. In particular, the computer programs, when executed, enable processor 1203 to perform the features of embodiments of the present invention. Accordingly, such computer programs represent controllers of computer system 1200.

In an embodiment where the invention is implemented using software, the software may be stored in a computer program product and loaded into computer system 1200 using removable storage drive 1214, hard drive 1212 or communications interface 1224. The control logic (software), when executed by processor 1203, causes processor 1203 to perform the functions of the invention as described herein.

In another embodiment, the invention is implemented primarily in hardware using, for example, hardware components such as application specific integrated circuits (ASICs). Implementation of hardware state machine(s) so as to perform the functions described herein will be apparent to persons skilled in the relevant art(s). In yet another embodiment, the invention is implemented using a combination of both hardware and software.

While various embodiments of the present invention have been described above, it should be understood that they have been presented by way of example only, and not limitation. It will be understood by those skilled in the art that various changes in form and details may be made therein without departing from the spirit and scope of the invention as defined in the appended claims. Thus, the breadth and scope of the present invention should not be limited by any of the above-described exemplary embodiments, but should be defined in accordance with the following claims and their equivalents.

What is claimed is:

1. A language tutor system comprising:
a client module;
a server module coupled to the client module, the server module to download an oral language assignment to the client module to enable a student learning a language to login to the client module and perform the oral language assignment,
wherein the client module to provide a benchmark audio sentence in the language to the student, to record a recitation of the sentence from the student, to evaluate the recitation of the sentence from the student, to compare the recitation of the sentence with the benchmark audio, and to provide feedback to the student on the comparison.

2. The system of claim 1, further comprising a client computing device coupled to the client module, wherein the student communicates with the client module using the client computing device.

3. The system of claim 1, further comprising a client computing device, the client computing device having a web browser to enable the student to communicate with the server module, wherein feedback from the comparison of the recitation of the sentence with the benchmark audio is uploaded to the server module to provide a learning history for the student.

4. The system of claim 3, wherein the feedback from the comparison of the recitation of the sentence by the student with the benchmark audio enables a teacher to customize oral language assignments for the student based on the student's weaknesses.

5. The system of claim 1, further comprising a computing device, the computing device having a web browser to enable a teacher to communicate with the server module, the server module comprising a content management module, the content management module to provide content for the oral language assignment downloaded to the client module.

6. The system of claim 1, further comprising a computing device, the computing device having a web browser to enable a teacher to communicate with the server module, the server module further comprising a homework management module, the homework management module to enable the teacher to provide homework assignments to the student, the homework assignments including a homework task, a list of the students to download the homework assignments to, a due date, a number of times the student is to complete the task, a minimum score for the homework assignment, and any comments from the teacher.

7. The system of claim 1, further comprising a computing device, the computing device to enable a teacher to communicate with the server module, the server module further comprising an information management module to receive results from the oral language assignment and provide learning histories to the student and the teacher and to enable the teacher to provide feedback to the student on the results from the oral language assignment.

8. The system of claim 1, wherein the feedback to the student comprises an evaluation of the student's pronunciation of each word in the sentence and each phoneme in the sentence and an evaluation of the intonation of each word in the sentence, wherein the evaluation of the intonation includes duration, stress, and pitch.

9. A language learning method comprising:
playing a benchmark audio to a student via a computing device, wherein the benchmark audio comprises a sentence recited in a language to be learned by the student;
recording a recitation of the sentence in the language by the student;
evaluating the recitation of the sentence from the student; and
comparing the recitation of the sentence from the student with the benchmark audio.

10. The method of claim 9, further comprising:
providing feedback on the comparison to the student and uploading the results of the comparison to a server module to enable a teacher having access to the server to evaluate the results and provide personalized feedback to the student via a web page.

11. The method of claim 9, further comprising:
providing feedback on the comparison to the student and uploading the results of the comparison to a server module to provide a learning history to the student and a teacher via a web page.

12. The method of claim 9, wherein evaluating the recitation of the sentence from the student comprises:
matching text from the benchmark audio with the recitation of the sentence by the student to separate the sentence into words and phonemes;
comparing the pronunciation of each word and phoneme by the student with the pronunciation of each word and phoneme from the benchmark audio; and
comparing the intonation of each word by the student with the intonation of each word from the benchmark audio.

13. The method of claim 12, wherein the intonation of each word comprises duration, stress, and pitch.

14. The method of claim 9, wherein the benchmark audio is downloaded from a server to a client module and wherein the client module plays the benchmark audio to the student via the client computing device.

15. A language tutor method comprising:
downloading an oral homework assignment from a server module to a client module to be distributed to a class of students for performing the oral homework assignment on a client computing device; and
enabling each student to login to the client module to perform the oral homework assignment;
wherein the client module evaluates oral responses from each student based on the oral homework assignment and provides feedback on the pronunciation and intonation of each word in the oral responses from each student.

16. The method of claim 15, further comprising:
uploading client module evaluations to the server module to enable a teacher having access to the server module to review the client module evaluations and provide personalized feedback to each student.

17. The method of claim 15, wherein feedback on the intonation of each word comprises duration, stress, and pitch for each word.

18. The method of claim 15, further comprising:
uploading information regarding whether or not each student in the class has performed the oral homework assignment.

19. The method of claim 15, further comprising:
uploading client module evaluations to the server module to provide learning histories on each of the students, wherein a learning history comprises the client module evaluations for each sentence recited by the student from all oral homework assignments.

20. An article comprising: a storage medium having a plurality of machine accessible instructions, wherein when the instructions are executed by a processor, the instructions provide for playing a benchmark audio to a student via a computing device, wherein the benchmark audio comprises a sentence recited in a second language;
recording a recitation of the sentence in the second language by the student;
evaluating the recitation of the sentence from the student; and
comparing the recitation of the sentence from the student with the benchmark audio.

21. The article of claim 20, further comprising instructions for:
providing feedback on the comparison to the student and uploading the results of the comparison to a server module to enable a teacher having access to the server to evaluate the results and provide personalized feedback to the student via a web page.

22. The article of claim 20, further comprising instructions for:
providing feedback on the comparison to the student and uploading the results of the comparison to a server module to provide a learning history to the student and a teacher via a web page.

23. The article of claim 20, wherein instructions for evaluating the recitation of the sentence from the student comprises instructions for:
matching text from the benchmark audio with the recitation of the sentence by the student to separate the sentence into words and phonemes;
comparing the pronunciation of each word and phoneme by the student with the pronunciation of each word and phoneme from the benchmark audio; and
comparing the intonation of each word by the student with the intonation of each word from the benchmark audio.

24. The article of claim 23, wherein the intonation of each word comprises duration, stress, and pitch.

25. The article of claim 20, wherein the benchmark audio is downloaded from a server to a client module and wherein the client module plays the benchmark audio to the student via the client computing device.

26. An article comprising: a storage medium having a plurality of machine accessible instructions, wherein when the instructions are executed by a processor, the instructions provide for downloading an oral homework assignment from a server module to a client module to be distributed to a class of students for performing the oral homework assignment on a client computing device; and
enabling each student to login to the client module to perform the oral homework assignment;
wherein the client module evaluates oral responses from each student based on the oral homework assignment and provides feedback on the pronunciation and intonation of each word in the oral responses from each student.

27. The article of claim 26, further comprising instructions for:
uploading client module evaluations to the server module to enable a teacher having access to the server module to review the client module evaluations and provide personalized feedback to each student.

28. The article of claim 26, wherein feedback on the intonation of each word comprises duration, stress, and pitch for each word.

29. The article of claim 26, further comprising instructions for:
uploading information regarding whether or not each student in the class has performed the oral homework assignment.

30. The article of claim 26, further comprising instructions for:
uploading client module evaluations to the server module to provide learning histories on each of the students, wherein a learning history comprises the client module evaluations for each sentence recited by the student from all oral homework assignments.

31. A language training system comprising:
an online client having oral language assignments designed to enable a student to orally practice a language to be learned by the student, the online client coupled to a client computing device to enable a student to login to the online client and perform the oral language assignments, wherein the online client to provide a benchmark audio sentence in the language to the student, to record a recitation of the sentence from the student, to evaluate the recitation of the sentence from the student, to compare the recitation of the sentence with the benchmark audio, and to provide feedback to the student on the comparison.

32. The system of claim 31, further comprising a storage device, wherein feedback from the comparison of the recitation of the sentence with the benchmark audio is stored on the storage device to provide a learning history for the student, wherein the learning history for the student is accessible to both the student and a teacher.

33. The system of claim 31, further comprising a second computing device, the second computing device having a web browser to enable a teacher to communicate with the online client, the online client comprising a homework management module, the homework management module to enable the teacher to provide homework assignments to the student, the homework assignments including a homework task, a list of the students to provide access to the homework assignments, a due date, a number of times the student is to complete the task, a minimum score for the homework assignment, and any comments from the teacher.

34. The system of claim 31, further comprising a second computing device, the second computing device having a web browser to enable a teacher to communicate with the online client, wherein the teacher, after reviewing the results of a comparison for a student, provides personalized feedback to the student via the online client.
